(19) United States
(12) Patent Application Publication
(10) Pub. No.: US 2005/0263372 A1
(43) Pub. Date: Dec. 1, 2005

(54) Feedback loop for bin sweep motors

(75) Inventors: Lyle Keith Hollander, Boyden, IA (US); Jesse Jerome Harmer, Sioux Falls, SD (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Sudenga Industries, Inc., George, IA (US)

(21) Appl. No.: 10/844,539

(22) Filed: May 12, 2004

(51) Int. Cl. B65G 33/08

(52) U.S. Cl. 198/550.1

(57) ABSTRACT

A feedback system for use with a bin sweep to control the movement of the bin sweep around a grain bin by measuring the amount of amperage that is drawn by an auger motor. If the amount of amperage that is drawn exceeds a specified level, a tractor motor stops the movement of the bin sweep. If the amount of amperage drawn is equal to or below a specified level, the tractor motor starts the movement of the bin sweep again. Regardless of the movement of the bin sweep and the state of the tractor motor, once the auger motor is turned on and the rotation of the auger has begun, the auger will still continue to rotate regardless of what the tractor motor is doing.

### CROSS-REFERENCE TO RELATED APPLICATION(S)

None.

### BACKGROUND OF THE INVENTION

This invention relates to bin sweeps for moving and clearing of stored materials from grain silos and similar storage units. Specifically, this invention relates to auger motors and motors located on the bin sweep that help coordinate the movement of the sweep in the storage bin.

A bin sweep is generally found at the bottom of a grain bin containing a flat bottom floor. Typically, the grain bin has a circular horizontal cross-section. Diameters of grain bins vary from several feet to over one hundred feet. A bin sweep must cover, at a minimum, the radius of the bin so that it is able to sweep the entire area of the bin as it rotates about an axis in the center of the grain bin.

To remove the stored material from a grain bin, an opening at the bottom of the grain bin is opened to allow the grain to flow through by gravity. The grain flows like a viscous fluid much like the sand in an hourglass. Grain will flow into the floor opening until flow from gravity stops leaving grain at the sides of the bin resting at the angle of repose. The empty space in the bin is the shape of an inverted cone with the point at the floor opening and the circular base at the top level of the remaining grain. The grain remaining in the bin must be removed. The bin sweep in a grain bin removes the remaining grain or other stored material that will not be moved by gravity alone.

Bin sweeps, typically include an auger that rotates about a central axis for conveying grain that is lying on the floor of the grain bin towards an opening in the central part of the floor of the grain bin. The auger of the bin sweep extends from the center of the bin to the bin's circumference and is mounted adjacent to the central opening, usually through the use of some means to provide that the bin sweep may pivot around an axis at the central floor opening. The bin sweep acts to convey grain toward the central floor opening as it gradually travels on an angular path within the grain bin, and eventually travels over the entire floor, surface of the grain bin.

A power source such as an electric motor is mounted to, the central structure for supplying rotational power to the auger. Additionally, a driving means is typically used with the bin sweep for propelling the bin sweep about the central opening in the floor, and commonly includes wheels or a track drive that will establish traction on the floor of the grain bin. The power source that drives the auger can supply the power to the floor engaging drive wheels or tracks which drives the bin sweep within the grain bin. However, a separate power source may be attached to the bin sweep to supply power to the drive wheels or tracks which propel the bin sweep within the grain bin.

The wheels which rotationally drive the bin sweep are generally positioned behind the auger. In such a system, one or more tractor wheels engage the floor or a track positioned behind the auger. The tractor wheels are typically mounted to the auger to provide support which keeps the auger from engaging the floor of the bin. The tractor wheels are attached to a power source such as a motor, to provide movement of the bin sweep around the bin.

Ideally, the two motors work independently of each other. The separateness of the two motors can create problems including where one motor encounters more stress than the other motor. This creates premature burn out for one of the motors or adds, to the wear and tear of both of the motors. An example of this stress inequality is when the auger motor encounters deep areas of the stored material that the auger must move to empty the bin. As the auger motor rotates the auger to convey the stored grain to the outlet, the tractor motor will continue move the grain bin sweep around the bin, which pushes the auger further into the stored material forcing the auger and auger motor to work harder to remove the stored material from the bin. At the same time, the tractor motor will work harder to force the tractor of the bin sweep through the remaining stored material.

One form of conventional bin sweep transmits power hydraulicly from the auger power source to the drive structure. If such a system is used, a hydraulic pump driven by a power source is attached to a plurality of hydraulic lines which extend along the frame of the bin sweep to power a hydraulic pump which drives the tractor wheels. The long hydraulic lines tend to require large amounts of hydraulic fluid, which requires a hydraulic tank to be relatively large. Also, the relatively long distances of the hydraulic lines extending to the end of the bin sweep tend to cause the fluid to incur loss of hydraulic pressure as the fluid travels within the hydraulic lines. Hydraulic pumps and motors must therefore be sized large enough to compensate for the energy loss incurred by length of the hydraulic lines that extend out to the end of the bin sweep to the drive wheels. This sizing of equipment adds to the overall bulk of the bin sweep which creates a large disadvantage in the fixed space of the grain bin. Further, hydraulic motors usually contain electric pumps which require electrical connections and components in addition to the hydraulic system.

Therefore, a grain bin sweep where both the auger motor and the sweep drive motor work in conjunction with each other in order to provide an effective method of removing the stored material within a grain storage facility without unequal stress on the motors is needed.

### BRIEF SUMMARY OF THE INVENTION

The present invention includes a feedback system that can be used with a grain bin sweep to control the movement of the bin sweep. The feedback system provides communication between an auger motor that controls the rotation of the auger with a tractor motor which controls the movement of the bin sweep around the grain bin. The feedback system monitors an amount of amperage that is drawn by an auger motor. When the amount of amperage exceeds a specified level a signal is sent to the tractor drive motor to disengage the tractor drive motor. Once the amount of amperage meets or falls below the specified level, a signal is sent to engage the tractor drive motor. Regardless of the whether the tractor drive motor is engaged or disengaged, the auger motor still continues to cause the auger to rotate.

### BRIEF DESCRIPTION OF THE DRAWINGS

FIG. 1 is a top view of a bin sweep of the present invention with a grain storage facility.

FIG. 2 is a side view of the inventive bin sweep within a grain storage facility.

FIG. 3 is a rear perspective view of the inventive bin sweep.

FIG. 4 is a side view of the outer edge of the inventive bin sweep in a partially filled grain storage facility.

FIG. 5 is a side view of the outer edge of the inventive bin sweep after the sweep has removed the stored material from a section of the bin.

FIG. 6 is a ladder logic diagram of the wiring of the inventive bin sweep.

While the above-identified drawings set forth one embodiment of the present invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention.

### DETAILED DESCRIPTION

The present invention allows for controlled movement of a grain bin sweep around a grain bin through a feedback system that measures an amount of amount of amperage that is being drawn from an auger motor. The present invention is further explained with reference to the drawing figures, wherein like structures are referred to by like numbers throughout the several views.

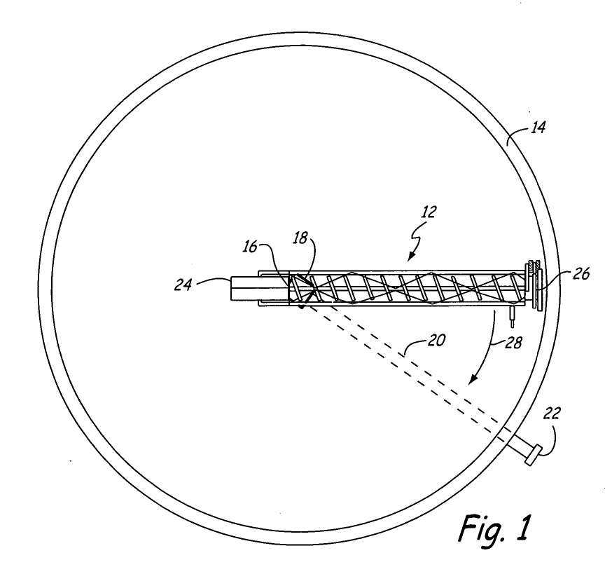

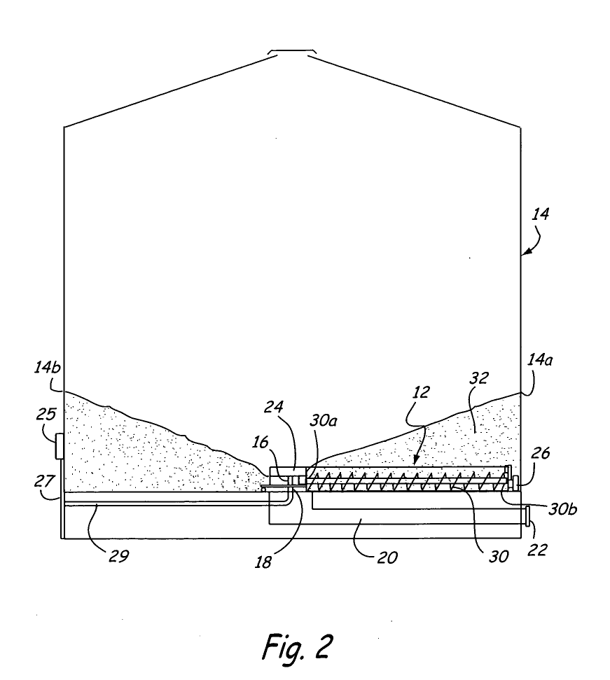

FIG. 1 shows a top view of a bin sweep 12 as it would appear in use in grain bin 14. Grain bin 14 is a storage facility typically cylindrical with a flat floor, well known within the art. Bin sweep 12 rotationally moves around central pivot axis 16 within grain bin 14. Bin sweep 12 conveys grain in the grain bin 14 from the outer circumference of grain bin 14 to a floor opening 18. Typically floor opening 18 is centrally located within the grain bin 14 with central pivot axis 16 centrally located within the area of floor opening 18. Upon reaching floor opening 18, the contents of the grain bin 14 drop onto a conveyor 20, and are transported out of grain bin 14 via conveyor 20 (see FIG. 2). Typically, conveyor 20 is a screw auger within an enclosed tube. The screw auger transports the stored grain through conveyor 20 to a discharge opening 22 which provides access to the grain outside of grain bin 14.

Bin sweep 12 has a first support structure 24 connected at a first end which rotates around central pivot axis 16. First support structure 24 comprises a pivot axis housing unit, an auger motor, and motor cover assembly. The auger motor is an electric motor connected to wiring that allows for control of the motor from the exterior of grain bin 14. The auger motor provides power to turn an auger 30 of bin sweep 12 about a generally horizontal axis as the bin sweep 12 moves through the grain bin 14.

First support structure 24 is mounted to pivot about a vertical axis centrally located about floor opening 18 about central pivot, axis 16. In one embodiment, central pivot axis 16 is a rod extending vertically from the center of floor opening 18. A round metal, tube having an inner diameter nominally larger the diameter of the rod, is attached to the bin sweep 12. This design allows for rotational movement of the tube, about the rod of central pivot axis 16.

Bin sweep 12 also has a second support structure 26 at a second end. Bin sweep 12 moves radially around grain bin 14 in a direction noted by arrow 28. Second support structure 26 can be comprised of any suitable means which would be able to support the second end of bin sweep 12 and aid in the maneuvering of the entire bin sweep 12. In the preferred embodiment, second support structure 26 comprises a motorized tractor to propel bin sweep 12 about central pivot axis 16.

FIG. 2 is a side view of the inventive bin sweep 12 within a grain storage facility. Bin sweep 12 extends radially out from central pivot axis 16 towards the edge of grain bin 14. Second support structure 26 is located at the end of bin sweep 12. As illustrated, stored material 32 has been emptied to a point where the stored material 32 has come to rest at the angle of repose. At this point of unloading grain bin 14, it is necessary to, engage bin sweep 12 so that auger 30 may remove the stored material 32 from the outer edges 14a and 14b of grain bin 14. As illustrated, the stored material 32 is at a level higher than the height of bin sweep 12. Auger 30 will transport the stored material 32 from outer edges 14a and 14b to floor opening 18 where it will drop onto conveyor 20 allowing for material to be removed via discharge opening 22.

The auger 30 contains a first end 30a and a second end 30b. The first end 30a is rotatably connected adjacent to first support structure 24, while the second end 30b is rotatably connected adjacent to second support structure 26. Auger 30 is comprised of a central rod or pipe with a sized helical flighting attached thereto, as is common in the art. Auger 30 may be comprised of either metal or polymers. The length of the auger 30 is nominally that of the length of the radius of grain bin 14.

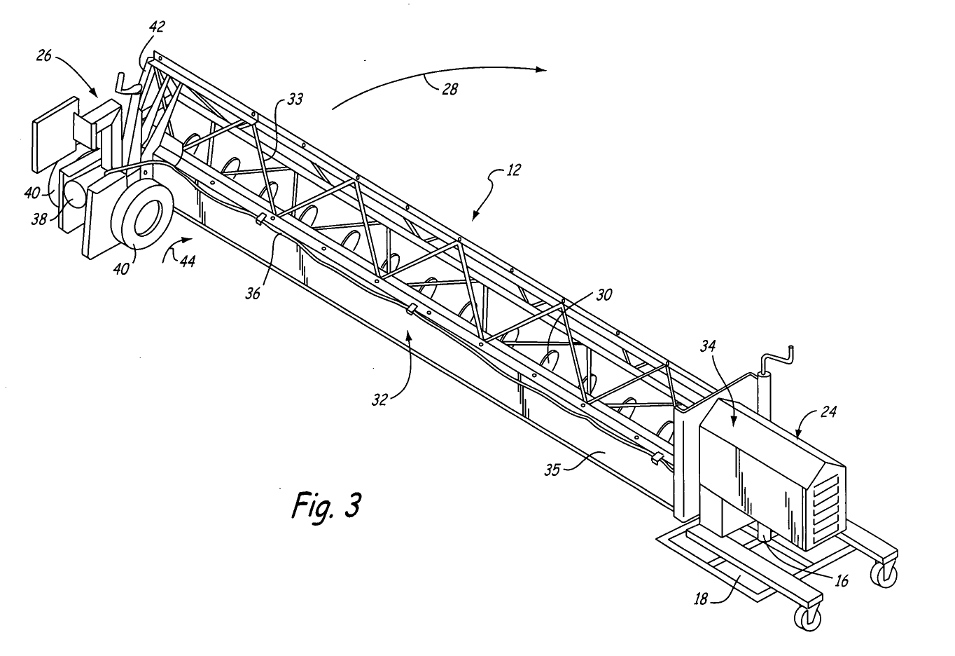

Also shown in FIG. 2 is a control panel 25 connected to a power source 27. Power source 27 is an electrical line that has been tapped into electrical utility service providing power to the location of grain bin 14. The control panel 25 contains basic electrical components for running the bin sweep 12. In one embodiment, the control panel 25 will comprise at least one current sensing relay, a plurality of indicator lights showing power to components of the bin sweep 12, a switch for setting a feedback system between three settings of (off), (manual), and (automatic), and a master power switch to engage and disengage power to the bin sweep 12. The control panel 25 also includes a forward/reverse switch for the motor which advances the bin sweep 12 around the grain bin 14 (drive motor 38—see FIG. 3).

A power line 29 extends from the control panel 25 to the motors of the first support structure 24 and second support structure 26. In one embodiment, power line 29 is a flexible metal conduit containing circuit wires encased in dielectric insulation, or a similar structure. In one embodiment, the power source 27 runs in a conduit that extends from the ground and terminates at control panel 25 along the side of grain bin 14. Power line 29 also runs in this conduit to a level below the grain bin floor, enters the well of grain bin 14, and then is run underneath the floor of the grain bin 14. The power line 29 extends through the floor to a location proximate to the first support structure 24. The power line 29 contains two separate cables to provide power to one motor mounted on first support structure 24 and one motor mounted on second support structure 26.

FIG. 3 is a rear perspective view of the inventive grain sweep. First support structure 24 is attached about central pivot axis 16 in center of floor opening 18. As illustrated, first support structure 24 contains an auger motor 34 encased in a protecting housing. The auger motor 34 provides the power to rotate auger 30 about a vertical axis. A hard wiring 36 extends from first support structure 24 about a support structure 32 connected to auger 30, and extends to drive motor 38 on second support structure 26. Hard wiring 36 is an insulated cable containing jacketed wires capable of carrying electrical current to run electrical motors, which is common in the art. In one embodiment, the hard wiring 36 is an insulated cable that is one of the circuit wires contained within power cable 29 that enters the grain bin 14 proximate to first support structure 24 (not illustrated in FIG. 3).

Support structure 32 of auger 30 is comprised of a frame 33 and a backshield 35. Support structure 32 can be connected to auger 30, first support structure 24, and second support structure 26 through any suitable means which may include, but is not limited to, bolting, welding, clamping and soldering, and suitable bearings to permit auger rotation. The frame 33 adds structural support to hold auger 30. The backshield 35 assures stored material 32 is conveyed to floor opening 18 by hindering grain kernels from being thrown from the front side of bin sweep 12 to the back side of bin sweep 12 and out of the path of auger 30. Grain moves along the flighting of screw auger 30 towards floor opening 18 with the backshield 35 holding grain in place until the grain is moved by the auger 30. In the preferred embodiment, the hard wiring 36 is attached to the support frame 32 to prevent the hard wiring 36 from coming in contact with the auger 30 and being ripped or torn by the auger 30.

Second support structure 26 comprises the drive motor 38 and drive wheels 40 near the outer end 42 of bin sweep 12. In one embodiment, drive wheels 40 and drive motor 38 are attached to a frame of second support structure 26 using standard fasteners such as nuts and bolts. In an alternate embodiment, drive wheels 40 are attached to the second end 30b of auger 30 through the use of bearings and appropriate fasteners. Drive motor 38 acts to propel drive wheels 40 in the direction of arrow 44 causing the bin sweep 12 to rotate in a clockwise fashion represented by arrow 28. Drive wheels 40 are connected to drive motor 38 on second support structure 26 to allow for rotational movement of drive wheels 40.

Suitable means for attachment of drive wheels 40 to drive motor 38 include a belt and pulley system; a chain and sprocket system; tie rods; intermeshed gears or similar power translation structures. In one embodiment, drive motor 38 is sized to allow adequate power to drive wheels 40 forward while supporting the weight of the outer end 42 of bin sweep 12. Further, it is preferred that the drive motor 38 be a reversible motor to allow for a powering of the drive wheels 40 in a direction opposite of arrow 44, so that the bin sweep 12 may be rotated about central pivot axis 16 in a counter-clockwise direction.

Bin sweep 12 includes a feedback system for the motors 34 and 38. The feedback system comprises power supply 27, auger motor 34, auger 30, drive motor 38, and support frame 32. The power supply 27 is connected to the auger motor 34 via electrical wiring through control panel 25. The auger motor 34 is attached to auger 30 by a physical connection such as a bearing and bearing holder, or other common rotatable coupling device. The auger motor 34 is electrically connected to drive motor 38 via a sensor system that contains a feedback loop with a current sensing relay. The sensor system provides a feedback signal which is a function of the amount of amperage drawn by auger motor 34 which is used to control the activation of the drive motor 38

The power supply 27 provides power to the feedback system by supplying the auger motor 34, and current sensing relay with power. The current, sensing relay in turn then supplies drive motor 38 with power. Drive motor 38, which is physically connected to bin sweep 12 by attachment of second support structure 26 to bin sweep 12, controls the advancing movement of bin sweep 12.

Once the power supply 27 is engaged by activating a control switch in control panel 25, power is supplied to the auger motor 34 which in turn causes auger 30 to rotate. The power supply 27 also provides power to drive motor 38 upon being engaged. When drive motor 38 is supplied with power and set to move the bin sweep 12 in a forward direction, it advances bin sweep 12 around grain bin 14 in the direction of arrow 28. The rotation of auger 30 and advancement of bin sweep 12 moves the grain from the outer circumference of grain bin 14 towards the central floor opening 18, which conveys the stored material 32 out of the grain bin 14.

As auger 30 rotates, a current sensing relay indicates how much amperage is being drawn by auger motor 34. As the amount of stored material 32 being conveyed by auger 30 increases, the amount of electrical current also increases, and thus more amps are drawn by the auger motor 34. The increase in amperage drawn by auger motor 34 derives from the need for more power to rotate auger 30 as more stored material 32 and thus weight, is being conveyed by auger 30. When the amount of amperage exceeds a specific level, which can be customized to a level determined by the user, the current sensing relay stops the supply of power to drive motor 38, thus disengaging the drive wheels 40.

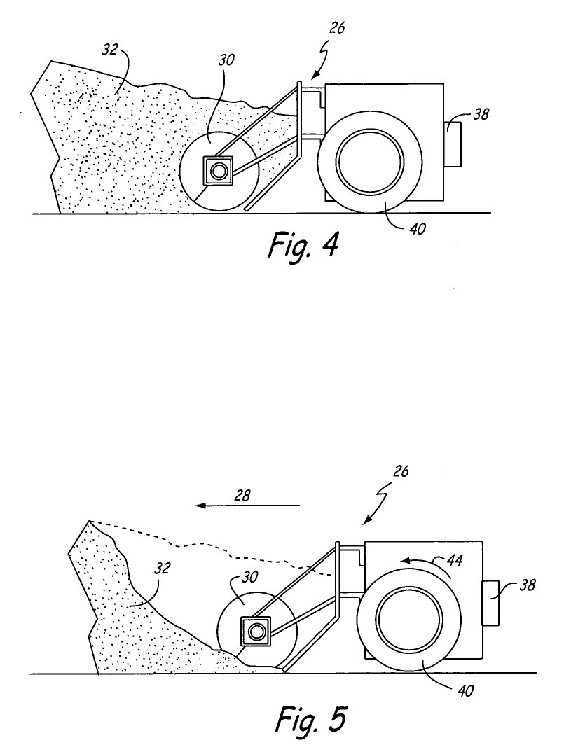

FIG. 4 illustrates a side view of second support structure 26 before power has been engaged to the drive motor 38 for drive wheel 40. Auger 30 is completely covered with stored material 32. When auger 30 is fully covered by stored material 32, as illustrated in FIG. 4, the amperage drawn by auger motor 34 will exceed, the limit and the current sensing relay has disengaged drive motor 38. When drive motor 38 ceases to receive power, this in turn causes drive wheels 40 to stop advancing, and thus, causes bin sweep 12 to stop moving across grain bin 14. Auger motor 34 remains activated, and this auger 30 continues to rotate during the time that drive motor 38 is disengaged.

FIG. 5 depicts second support structure 26 in a position after auger 30 has been conveying stored material 32 out of grain bin 14 while drive motor 38 has been disengaged. Once the amount of stored material being conveyed by auger 30 drops to a level where the auger 30 is only running at a certain percentage of its grain movement capacity as illustrated in FIG. 5, the amperage drawn by the auger motor 34 will drop below the second specified level so that the current sensing relay engages the drive motor 38. Once the amount of amperage drawn from the auger motor 34 meets or drops below a second specified level, the current sensing relay switches and starts the supply of power back to drive motor 38. This in turn causes bin sweep 12 to advance forwardly within grain bin 14 again in the direction of arrow 28 by turning drive wheels 40 in the direction 44.

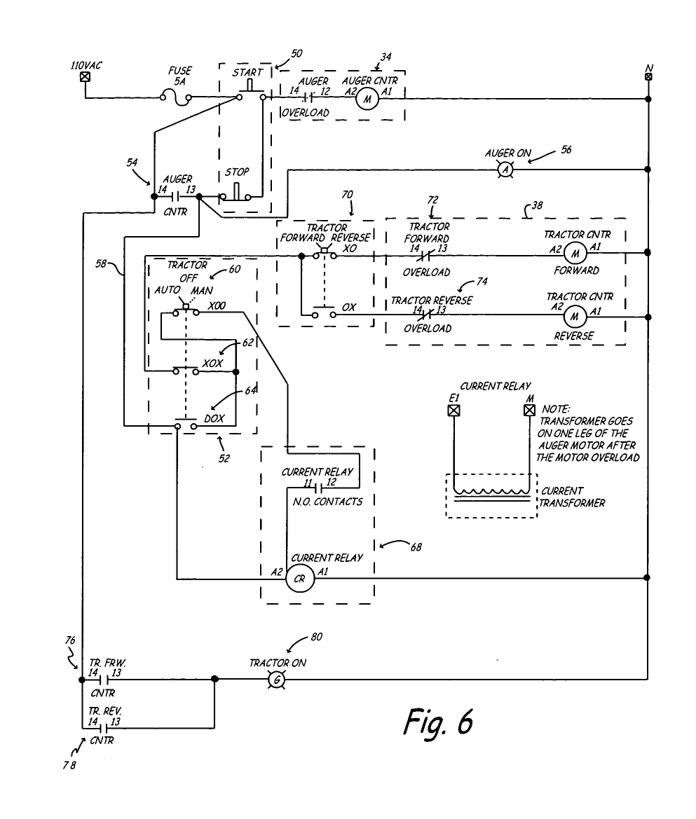

In one embodiment, the feedback system is wired in accordance with the ladder logic diagram of FIG. 6. Power to the system is, controlled by master switch 50, which is located on the control panel 25. Upon engaging switch 50 into the start position, the auger motor 34 which rotates auger 30 will be engaged. The auger motor 34 must provide enough power to rotate an auger 30 fully submerged beneath stored material 32. In one embodiment, the auger motor 34 is a three phase, 208-240 volt electric motor delivering between seven and one-half and ten horsepower with an overload amperage of approximately 22 amps. Engaging switch 50 engages a contactor 54 which starts the auger motor 34. Operably connected to contactor 54 is an indicator light 56 which indicates that the auger motor 34 is activated and thus that the auger 30 is running.

An electrical line 58 continues from the auger motor 34 contactor to provide the feedback loop for the drive motor 38. The feedback loop is created with a current sensing relay. In one embodiment, the current sensing relay has three positions: “off”, “automatic”, and “manual”. Selection between the three positions is obtained by moving a toggle switch 52 on the control panel 25 to the appropriate selection. In FIG. 6, the toggle switch 52 is shown in the “auto” position 60, which creates a closed loop at the “off” position 62 and open loop at the “manual” position 64. Upon engaging switch 50, the tractor motor, or drive motor 38 is powered on.

When the toggle switch 52 is in the automatic position 60, power runs through a current sensing relay 68. When the amperage draw from the auger motor 34 reaches a predetermined level, a current sensing relay 68 shuts off the drive motor 38. As grain is emptied out of the grain bin 14, the amperage draw on auger motor 34 will drop below the predetermined level and the drive motor 38 will again engage.

Current runs through line 58 into current sensing relay 68 located in the control panel 25. In one embodiment, the current sensing relay 68 is a 110 volt current control relay comprising an adjustable hysteresis and threshold level. The threshold is a set current level, and the hysteresis is a percentage of the threshold. The relay will cut power to drive motor 38 upon reaching the threshold current level, and restore power to the drive motor 38 upon reaching the current level set by the hysteresis.

For example, if a threshold level of ten amps is set with a fifty percent hysteresis, when the system is started by switch 50 in the auto position 60, the current relay 68 will disengage power to the drive motor 38 upon reaching a current level of ten amps. During this time, the auger motor 34 will continue to run. Once the current level has fallen to 50 percent of the threshold current level, (i.e. reaches five amps), power will be restored to the drive motor 38. In this example, the auger motor 34 is seven and one-half horsepower motor, which will draw between three and four amps when the auger 30 is running completely empty within a grain bin 14. Thus, the drive motor 38 will rotate the bin sweep 12 before the auger 30 runs completely empty.

In one embodiment, the drive motor 38 is a three phase, 208-240 volt, three-fourths or two horsepower reversible motor, depending on the length, and thus weight, associated with bin sweep 12. Drive motor 38 is provided a reversing switch 70. When the reversing switch 70 is engaged in the forward position, a forward contactor 76 is engaged and the drive motor 38 will move the bin sweep 12 in the forward direction (clockwise, like arrow 28). When the reversing switch 70 is moved to the reverse position, a reverse contactor 78 is engaged and the drive motor 38 will be activated (in reverse) to drive the bin sweep 12 in a counter-clockwise direction. Such a feature improves the mobility of the bin sweep 12 within the grain bin 14 by allowing the bin sweep 12 to move in either direction about central pivot axis 16. Absent a reversible motor, the drive motor 38 only powers the bin sweep 14 in a clockwise direction and thus does not allow for positioning within the grain bin 14 absent a forward revolution. With a reversible motor, the bin sweep 12 can be positioned in a counter-clockwise direction through use of the tractor, thus negating the need for manual placement. A reversible drive motor 38 allows the bin sweep 12 to move in a rearward direction if it encounters an obstacle that cannot be or should not be transported to the center of the grain bin 14 by the auger 30. Both drive motor 38 contactors 76 and 78 are also connected to an indicator light 80. Thus, if the tractor is moving in either direction, the indicator light 80 will illuminate. Preferably, the indicator light 80 is contained on the control panel 25.

The drive motor 38 also contains an overload for both the forward and reverse directions. When the bin sweep 12 is put into “manual” position 64, toggle switch 52 closes a loop so that power is running to the drive motor 38 regardless of the amount of current being sent current sensing relay 68. Overload protection prevents the drive motor 38 from burning out if the amperage draw becomes too great while the drive motor 38 is running, especially if the tractor is in the manual mode. Separate overload protectors 72 and 74 are provided for each respective set of forward and reverse tractor motor contactors 76 and 78.

The present feedback loop system allows for a method of controlling the advancement of a bin sweep 14 within grain bin 12. The feedback system provides for the monitoring an amount of amperage drawn by auger motor 34 on bin sweep 12. Activating the system will initially activate auger motor 34 and drive motor 38 which advances bin sweep 12 through grain bin 14. When the amount of amperage drawn by auger motor 34 exceeds a specified level, the feedback loop drive motor 38, which in turn stops bin sweep 14 from advancing. Auger motor 34 remains running while drive motor 38 is disengaged. Next, when the amount of amperage drawn by auger motor 34 is equal or less than a second specified level, drive motor 38 is again activated to advance bin sweep 12.

In one embodiment (not illustrated), the feedback system contains radio frequency transmitters and receivers on the motors 34 and 38. The feedback system still contains a current sensing relay, but once the amperage draw exceeds or drops below the specified levels, a radio signal transmits from the auger motor 34 to a radio receiver on the drive motor 38 which is operably connected to the contactors for engaging and disengaging the drive motor 38. This embodiment eliminates the need for hard wire connection between the two motors 34 and 38.

Although the present invention has been described with reference to preferred embodiments, workers skilled in the art will recognize that changes may be made in form and detail without departing from the spirit and scope of the invention.

1. A feedback system for use with a grain bin sweep, the feedback system comprising:
an auger;
an auger motor connected to a first end of the auger for rotating the auger;
a bin sweep drive wheel connected to a second end of the auger;
a drive motor connected to the drive wheel for rotating the drive wheel, and
a sensor system for providing a feedback signal which is a function of an amount of amperage drawn by the auger motor for use in controlling activation of the drive motor.

2. The feedback system of claim 1 wherein the drive motor stops when the amount of amperage exceeds a specified level.

3. The feedback system of claim 2 wherein activation of the auger motor continues even when the drive motor has stopped.

4. The feedback system of claim 1 wherein the drive motor is oh when the amount of amperage is equal to or less than a specified amount.

5. A bin sweep comprising:
an auger having a first end and a second end;
a first auger support structure adjacent to the first end of the auger wherein the first support structure rotates about a vertical axis;
an auger motor adjacent to the first end of the auger;
a second auger support structure adjacent to the second end of the auger;
a drive wheel connected to the second auger support structure;
a drive motor connected to the drive wheel for rotating the drive wheel; and
a bin sweep movement control system for controlling activation of the drive motor based on monitoring an amount of amperage drawn by the auger motor.

6. The bin sweep movement control system of claim 5 wherein the drive motor stops when the amount of amperage exceeds a specified level.

7. The bin sweep movement control system of claim 6 wherein activation of the auger motor continues even when the drive motor has stopped.

8. The bin sweep movement control system of claim 5 wherein the drive motor is on when the amount of amperage is equal to or less than a specified amount.

9. A method for controlling the movement of a grain sweep within a grain bin comprising:
monitoring an amount of amperage drawn by an auger motor rotating an auger on a grain sweep within a grain bin;
moving the grain sweep through the grain bin by activation of a sweep advance motor;
stopping the sweep advance motor when the amount of amperage drawn by the auger motor exceeds a specified level, thereby stopping movement of the grain sweep within the grain bin; and
starting the sweep advance motor if the amount of amperage drawn by the auger motor is equal to or less than or beneath the specified level, thereby initiating movement of the grain sweep within the grain bin.

10. The method of claim 9 and further comprising:
maintaining activation of the auger motor after the sweep advance motor has been stopped.
